(19) United States
(12) Patent Application Publication
(10) Pub. No.: US 2002/0171223 A1
(43) Pub. Date: Nov. 21, 2002

(54) Automotive suspension performance spring and system

(75) Inventor: Chung Chan, Monterey Park, CA (US)

Correspondence Address: OPPENHEIMER WOLFF & DONNELLY LLP, 2029 CENTURY PARK EAST, 38TH FLOOR, LOS ANGELES, CA, 90067-3024, US

(73) Assignee: VIS Racing Sports, Inc.

(21) Appl. No.: 10/194,889

(22) Filed: Jul. 12, 2002

(51) Int. Cl. B60G 11/14

(52) U.S. Cl. 280/124.179

(57) ABSTRACT

An after-market automotive performance suspension spring and spring system includes a tapered helical coil suspension spring that tapers from a larger diameter upper end to a smaller diameter lower end, and has a substantially linear spring rate. The spring is used in conjunction with a height-adjustable adapter that adapts the lower spring end, which is smaller than the lower end of the stock automobile spring which it replaces, to the stock automobile lower spring seat. The larger diameter upper end of the spring is large enough to fit the stock upper spring seat of the automobile without requiring any modification to the pillar upper mount.

### CROSS REFERENCE TO RELATED APPLICATIONS

None.

### BACKGROUND OF THE INVENTION

1. Field of the Invention

The present invention relates to automotive suspension performance systems, and more particularly to a tapered helical coil suspension performance spring and spring system.

2. Description of the Related Arts

Independent automotive suspension systems such as the MacPherson strut suspension system are well known to the automotive industry. The prior art system of FIG. 1, for example, includes a helical coil spring 10 and a shock absorber 20. The upper end of spring 10 rests against the pillar upper mount which includes a spring upper seat 12 and a pillar cap 16. Between the spring upper seat 12 and pillar cap 16 there is a ball bearing 14 which allows the spring upper seat 12 to rotate slightly as the wheel experiences turns and bumps in the road. The lower end of spring 10 rests against the spring lower mount 18. The shock absorber 20 is mounted to wheel carrier 22, and the pillar upper mount is mounted to the vehicle body 26.

In order to make the suspension perform better during hard maneuvers, automobile owners often attempt to increase the stiffness of the stock suspension by replacing the stock spring with a stiffer spring. Automobile owners also raise or lower the vehicle's height above the ground by a variety of techniques, including employing different length springs sometimes in combination with spring adapters and spacers, and replacing other stock parts of the suspension system with after market performance parts. One technique which has been employed in the past is to replace the stock suspension spring with smaller and stiffer spring. The smaller spring sometimes requires an adapter at the lower end such as an externally threaded cylinder in combination with internally threaded collars such as have been sold by the assignee of the present invention. In some instances the smaller spring is not mechanically compatible with the spring upper mount due to the after market spring's smaller diameter. This has led some to modify the stock suspension mount by removing the spring upper mount 12 and bearing 14. One disadvantage to this modification is that it restricts the ability of the spring's upper end to rotate freely and causes an undesirable squeaking created by friction between the spring's upper end and the pillar cap or other non-rotating bushing or adapter that may be used between the spring and the pillar cap.

Another way to achieve increased suspension performance is to use a spring having thicker coils and hence a greater spring constant. A spring with thicker coils, however, would be heavier and more expensive than the smaller coils, and still may not mate properly to the spring upper and lower seats.

### SUMMARY OF THE INVENTION

In accordance with the present invention, an improved automotive performance suspension spring and spring system is provided in which a helical coil suspension spring having a generally constant spring rate tapers from a wider diameter first end to a smaller diameter second end. The wider diameter upper end has a diameter such that the upper end mechanically fits stock suspension spring upper mounts. The spring may be used in combination with an adjustable adapter at the spring lower end. The adjustable adapter both adapts the spring's smaller diameter lower end to stock coil lower seats, and provides a continuously variable height adjustment for the spring and hence for the vehicle. The tapered spring provides the advantages of both mating with the stock spring upper seat without requiring any modification to the pillar upper mount, and greater stiffness than the stock spring and hence improved suspension performance over the stock suspension system.

### BRIEF DESCRIPTION OF THE DRAWINGS

A detailed description of the preferred embodiment of the invention will be made with reference to the accompanying drawings, in which like numbers refer to like parts.

FIG. 1 is a partial cut-away side elevation view of a prior art MacPherson strut type suspension system;

FIG. 2 is an exploded perspective view showing the suspension spring system of the present invention;

FIG. 3 is a partial cutaway side elevation view showing the spring system of the present invention installed on a vehicle; and

FIG. 4 is a cutaway side elevation view of the performance suspension spring system of the present invention.

### DESCRIPTION OF THE PREFERRED EMBODIMENTS

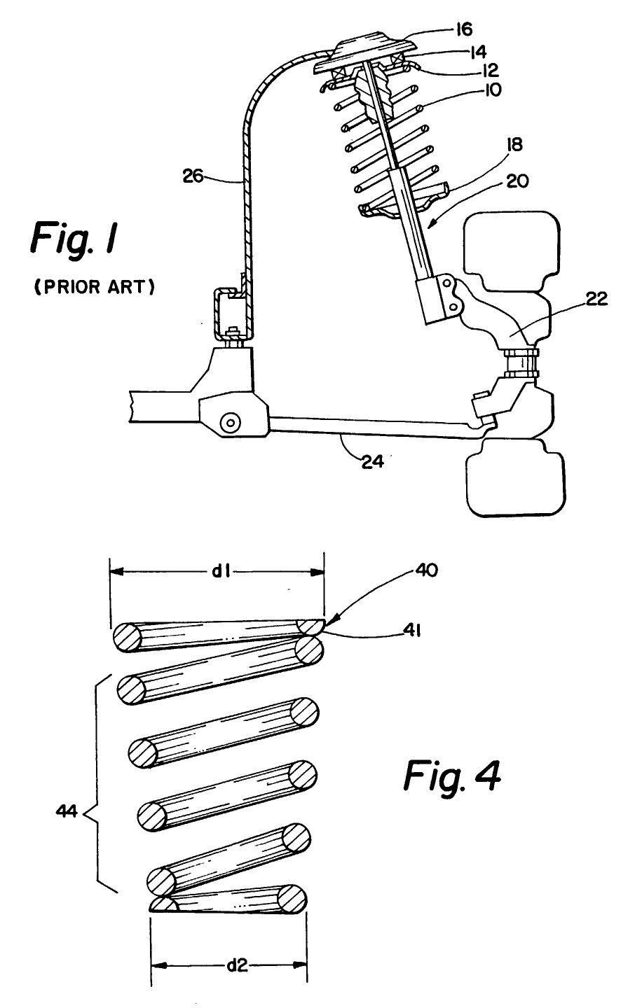

FIG. 1 shows a prior art McPherson strut suspension system. That system is described above.

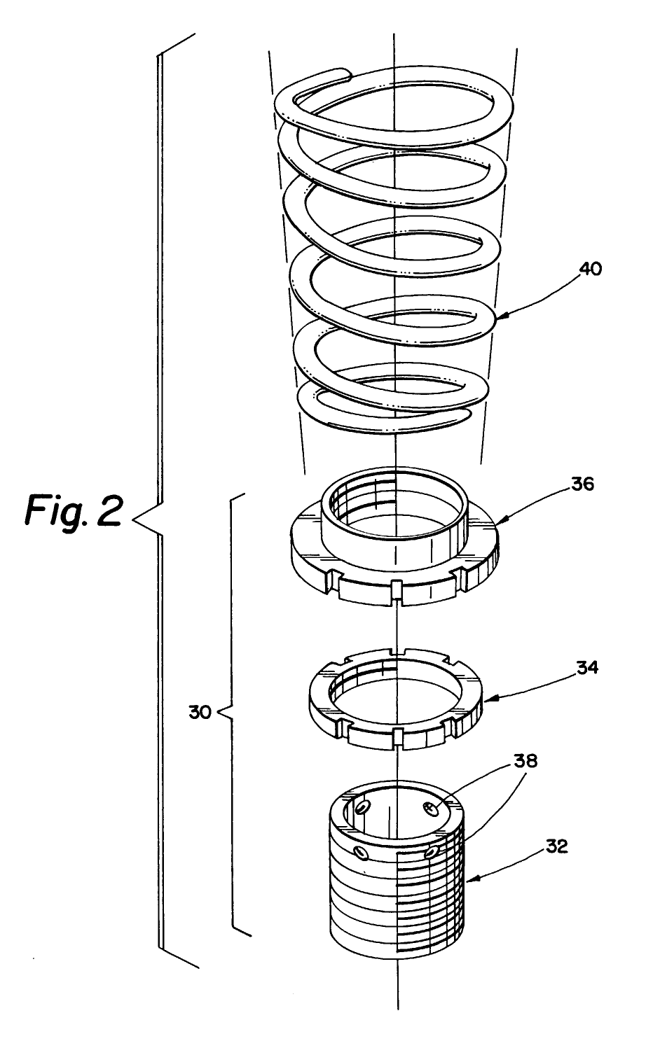

FIG. 2 shows one embodiment of the present invention including both a tapered performance suspension helical coil spring and an adapter for adapting the spring's smaller diameter lower end to an automobile stock lower spring mount. As shown more fully in FIG. 4 spring 40 includes a first end 41 having a first diameter d1, a second end 42 having a second diameter d2, and a spring body 44 therebetween. Coil diameters d1 and d2 are different, and the spring tapers from first and larger diameter dl to the smaller diameter d2. In the embodiment shown the spring tapers substantially uniformly across its length. Across the length of the spring body 44 successive coils are spaced substantially uniformly, giving the coil a substantially linear spring rate, or a spring constant. At the springs ends 41 and 42 the coil ends are preferably formed so that the spring ends present roughly circular contact areas or foot pads to rest against their respective spring supporting surfaces. This generally requires the coils at the ends to be planed off and bent closer to the preceeding turn, but other than that the successive coil turns are substantially evenly spaced. In the preferred embodiment the spring is substantially stiffer than the stock automobile suspension spring that it is designed to replace, thus providing more stability during cornering and other high speed maneuvers, and generally providing a stiffer suspension having greater performance than the stock suspension spring. In the preferred embodiment spring end 41 having the larger diameter dl is the upper spring end, and spring end 42 having the smaller diameter spring end is the lower spring end. The larger diameter d2 may be at least 5% larger than smaller diameter d2, at least 10% larger, or even more.

In the preferred embodiment spring upper end 41 has a diameter dl that fits into the stock upper spring seat 12 of a pillar upper mount of a McPherson strut suspension system on a stock automobile as assembled and sold by one of the major automobile manufacturers. Preferably spring upper end 41 fits such a stock spring upper seat 12 without requiring any adapter or modification. The spring system of the present invention therefore allows the entire stock pillar upper mount including the bearing 14 to be used. This eliminates problems associated with prior art suspension performance springs and mounting methods for such springs, in which the stock spring upper seat 12 and bearing 14 were removed and the spring upper end was simply abutted against the pillar upper cap or other static adapter, which eliminated the spring's ability to rotate freely and noiselessly while driving and maneuvering.

Spring 40 is preferably used in combination with an adapter such as adapter 30 for adapting the spring's lower end 42 to the stock lower spring seat of an automobile. In the preferred embodiment adapter 30 includes a cylindrical body 32 and a pair of collars 34 and 36, all of the type previously sold by the assignee of the present invention. Cylindrical body 32 is externally threaded, and collars 34 and 36 are internally threaded such that collars 34 and 36 can be threaded onto body 32. Collars 34 and 36 can then be tightened against each other to prevent further rotation of the collars. Collars 34 and 36 therefore function as locknuts to lock the adjuster at the desired height. Collars 34 and 36 are preferably provided with notches around their outer diameters such as shown in FIG. 2 so that a tool can be used to tighten or loosen them, or even adjust their positions when the spring system is fully installed in an automobile. Adjuster body 32 is smaller than the inner diameter of spring lower end 42 and thus is partially received therein. Adjuster body 32 includes 4 tapped through-holes 38 for receiving set screws (not shown). The set screws allow the adapter to be securely tightened to the lower half of the suspension system. Upper collar 36 is sufficiently wide to form a seat for spring lower end 42. Thus, upper collar 36 defines a flange or support surface for spring lower end 42.

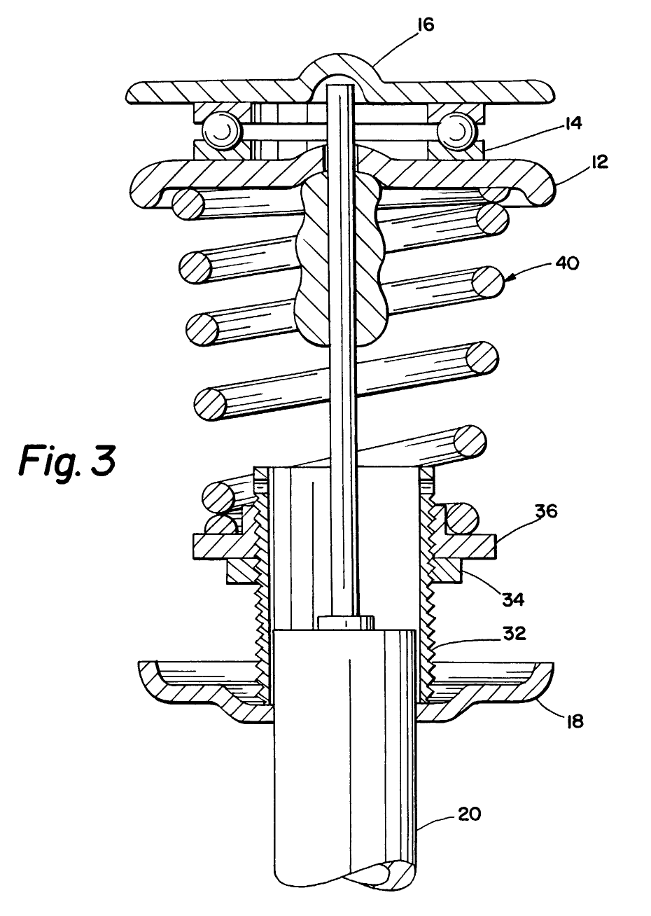

FIG. 3 shows the spring system of the preferred embodiment installed in an automobile. The stock suspension parts include spring lower seat 18 and spring upper seat 12, rotatably supported in or against pillar cap 16 by bearing 14. In the stock system, a spring having uniform diameter would extend from upper seat 12 to lower seat 18. In accordance with the present invention, however, such a stock spring has been replaced by tapered performance spring 40 and adapter 30. Adapter body 32 is fitted on the outside of shock absorber 20 and rests against stock spring lower seat 18. Collars 34 and 36 are threaded onto adapter body 32, and flanged upper collar 36 forms the seat on which spring 40 rests. Thus, adapter 30 provides a mechanical mating between spring lower end 42 and the stock suspension spring lower seat 18. Because the upper end of spring 40 is formed to mechanically mate to the stock spring upper seat 12 without requiring any modification, spring 40 can rotate via the action of bearing 14 during driving and maneuvering, providing advantages over certain other prior art attempts to provide improved suspension performance.

Because collars 34 and 36 can be rotated to adjust their heights, the adapter provides a continuously adjustable height adjustment by which the spring's lower end, and hence the height of the car itself above the ground, can be continuously adjusted or varied. Other types of adapters may be used with the tapered spring of the present invention, including both adapters currently within the art as well as adapters which have not yet been designed, and including adapters that merely provide a static mechanical interface between the spring lower end 42 and spring lower seat 18 without providing the advantage and ability to continuously adjust the height of the spring lower support surface as provided by the adapter shown and described herein.

One of the advantages of the present invention is that it allows the suspension to be stiffened while lowering the automobile significantly, i.e., and provide a height adjustment, by only replacing the stock spring with the tapered spring and adapter system of the present invention. Previous methods for accomplishing those goals required more extensive modifications to the stock automobile. Another advantage of the spring and spring system of the present invention is that it requires only a limited number of parts to be stocked by the after-market parts supplier. The adapter can be manufactured so as to fit a wide variety of stock vehicles. Different springs can be manufactured to have the same lower diameter to fit the adapter, but different upper diameters to fit the various stock automobiles on which they may be used. In this way a parts seller can stock springs having a variety of different upper diameters and stiffnesses, determine which spring will be suitable for a customer's automobile based on the diameter of the stock upper spring seat as well as the appropriate stiffness of the replacement spring, and sell to the customer the selected spring and a standard adapter.

In one method of employing the present invention, an after-market parts supplier offers for sale a tapered suspension spring that is stiffer than the stock suspension spring that it is intended to replace. As a further refinement of the method, the parts supplier also offers for sale an adapter that will adapt the tapered spring for use in an automobile wherein the adapter allows the tapered spring to be used with other stock suspension parts of the automobile. The adapter mechanically interfaces one end of the spring to one of the stock spring seats. In another method of employing the present invention, a stock non-tapered suspension spring is replaced with a tapered suspension spring that is stiffer than the stock suspension spring that it is intended to replace. As a further refinement of the method the tapered spring is installed in the vehicle in combination with an adapter to adapt at least one end of the spring to existing parts of the vehicle suspension system. Both the spring and adapter may be, for example, as described and illustrated in the foregoing.

Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents. In the following claims, those claims which contain the words “means for” are intended to be interpreted in accordance with 35 U.S.C. §112, paragraph 6; those claims which do not include the words “means for” are intended to not be interpreted in accordance with 35 U.S.C. §112, paragraph 6.

What is claimed is:

1. An automotive suspension performance enhancement system comprising:
a tapered helical coil spring, said spring having:
a first spring end and a second spring end, said first spring end having a diameter that is greater than a diameter of said second spring end; and
a spring body which tapers in diameter from said first spring end to said second spring end; and
an adapter for mechanically interfacing one of said first spring end and said second spring end to a stock automobile suspension spring lower seat, said adapter having an adjustment for adjusting a distance between said spring lower seat and one end of said tapered helical coil spring end.

2. The system of claim 1 wherein the diameter of said first spring end is at least 10 percent greater than the diameter of said second spring end.

3. The system of claim 1 wherein:
said spring has a substantially linear spring rate;
said spring body tapers substantially uniformly from said first end to said second end;
said first spring end is an upper spring end that mates with a stock upper spring seat of an automobile without requiring any modification to said stock upper spring seat; and
said adapter comprises a cylinder and at least one collar for threadingly engaging an outer surface of said cylinder.

4. The system of claim 1 wherein said adapter comprises a cylinder and at least one collar for threadingly engaging an outer surface of said cylinder.

5. The system of claim 1 wherein:
said spring body tapers substantially uniformly from said first end to said second end; and
said spring has a substantially linear spring rate.

6. An automotive suspension performance spring comprising:
a helical coil spring having a larger diameter first end, a smaller diameter second end, and a spring body therebetween, the spring body tapering substantially uniformly from the first end to the second end, wherein successive turns of said helical coil are substantially uniformly spaced across the spring body.

7. The suspension performance spring of claim 6 wherein the diameter of said first end is at least 5% greater than the diameter of said second end.

8. The suspension performance spring of claim 6 wherein the diameter of said first end is at least 10% greater than the diameter of said second end.

9. The suspension performance spring of claim 6 wherein:
said first end is an upper end which mates with an spring upper seat of a stock automobile without requiring any modification or adapter; and
said second end is a lower end which does not mate with a spring lower seat of said stock automobile without requiring any modification or adapter.

10. The suspension performance spring of claim 6 wherein said spring has a greater spring rate than a stock suspension spring for said automobile.

11. The suspension performance spring of claim 6, in combination with a continuously adjustable flange for adjusting a height of said spring second end.

12. The suspension performance spring of claim 6, in combination with an adapter for mechanically matching said spring lower end to a stock spring lower seat.

13. The suspension performance spring of claim 12 wherein said adapter has an adjustment for adjusting a distance between said spring lower end and said stock spring lower seat.

14. The suspension performance spring of claim 6, in combination with a spring adapter, the spring adapter comprising:
a generally cylindrical adapter body having threads on an outer surface thereof, and
at least one internally threaded collar for threadingly engaging said adapter body, said adapter body being at least partially receivable within said spring lower end, and said collar having a diameter sufficiently large for seating said spring lower end thereon.

15. A method of obtaining increased suspension performance of an automobile comprising the steps of:
removing from an automobile an existing first automobile suspension spring;
replacing said first spring with:
a second spring having a generally uniform taper from a wider upper end to a narrower lower end, and
an adapter for adapting said spring lower end to a spring lower seat of said automobile.

16. The method of claim 15 wherein:
said second spring is substantially stiffer than said first spring; and
said adapter comprises a threaded adapter body and a plurality of threaded collars for threadingly engaging said adapter body, at least one of said collars defining a seat for supporting said lower end of said second spring;
the method further comprising the step of:
installing said second spring onto said automobile without modifying an existing spring upper mount of said automobile.

17. The method of claim 15 wherein said adapter comprises a threaded adapter body and a plurality of threaded collars for threadingly engaging said adapter body, at least one of said collars defining a seat for supporting said lower end of said second spring.

18. The method of claim 15 wherein said second spring is substantially stiffer than said first spring.

19. The method of claim 15 wherein said first spring is a non-tapered spring.

20. The method of claim 15 further comprising the step of installing said second spring onto said automobile without modifying an existing spring upper mount of said automobile.

21. A method of serving a market for automobile suspension performance comprising the steps of:
offering for sale an automotive suspension coil spring having a larger diameter first end and a smaller diameter second end; and
offering for sale an adapter for interfacing one end of said spring to an automobile suspension spring mount.

22. The method of claim 21 wherein said spring tapers substantially uniformly from said larger diameter first end to said smaller diameter second end.

23. The method of claim 21 wherein the diameter of said first end is at least 10% greater than the diameter of said second end.

24. The method of claim 22 wherein coils of said spring are substantially uniformly spaced.

25. The method of claim 21 wherein:
said first spring end fits a stock upper spring mount on automobiles without requiring any modification to said stock upper spring mount;
said adapter adapts said second spring end to a lower spring mount; and
said adapter includes an adjustable height adjustment for adjusting a distance between an automobile body and the ground.

26. The method of claim 25 wherein said height adjustment is continuously variable.

27. An automobile suspension spring system comprising:
a tapered helical coil automobile suspension spring; and
means for adapting said tapered helical coil suspension spring to be mechanically compatible with an existing automobile suspension system incorporating in its stock configuration a non-tapered helical coil suspension spring.

28. A method of serving the automotive after-market suspension performance parts market comprising the steps of:
stocking a plurality of different tapered helical coil suspension springs, each of said springs respectively having a smaller diameter end and a larger diameter end, said smaller diameter ends having substantially identical diameters, said plurality of springs including springs having a variety of larger diameters to fit standard suspension components in a respective variety of automobiles;
stocking adapters for adapting the smaller diameter ends of each of said plurality of different springs to a variety of automobiles, said adapters being substantially identical;
selecting at least one of said springs according to requirements for a customer's automobile; and
selling said selected spring and said adapter to said customer.
